(19) United States
(12) Patent Application Publication
(10) Pub. No.: US 2025/0315966 A1
(43) Pub. Date: Oct. 9, 2025

(54) ULTRASOUND SHAPE SENSING

(71) Applicant: CALIFORNIA INSTITUTE OF TECHNOLOGY, Pasadena, CA (US)

(72) Inventors: Morteza GHARIB, ALTADENA, CA (US); Alexandros ROSAKIS, ALTADENA, CA (US); Ioannis MANDRALIS, PASADENA, CA (US)

(21) Appl. No.: 19/169,810

(22) Filed: Apr. 3, 2025

Related U.S. Application Data
(60) Provisional application No. 63/573,677, filed on Apr. 3, 2024.
(60) Provisional application No. 63/664,245, filed on Jun. 26, 2024.
(60) Provisional application No. 63/695,447, filed on Sep. 17, 2024.
(60) Provisional application No. 63/749,855, filed on Jan. 27, 2025.

(51) Int. Cl. G06T 7/55; G01S 7/539; G01S 15/89

(52) U.S. Cl. CPC G06T 7/55; G01S 7/539; G01S 15/89; G06T 2207/10136; G06T 2207/20081; G06T 2207/20084; G06T 2207/30021

(57) ABSTRACT

The disclosure relates to techniques for sensing the shape of wires using ultrasound waves. In some implementations, a system includes: a wire, an ultrasound transducer acoustically coupled to the wire, and a processing device. The wire includes ultrasound reflection sites distributed along its longitudinal length, each ultrasound reflection sites including a surface feature that alters an acoustic impedance at the wire. The ultrasound transducer device is configured to: generate an ultrasound wave signal that travels along the longitudinal length and partially reflects from each of the reflection sites; and receive a reflected ultrasound waveform signal including data representative of a partial reflection of the ultrasound signal by each of the ultrasound reflection sites. The processing device is configured to: determine, based on the reflected ultrasound data signal, wire shape data of the wire; and reconstruct, based on the wire shape data, a shape of the wire.

### CROSS-REFERENCE TO RELATED APPLICATIONS

This application claims the benefit of U.S. Provisional Patent Application No. 63/749,855, filed Jan. 27, 2025, and titled “Ultrasound Shape Sensing”, U.S. Provisional Patent Application No. 63/695,447 filed Sep. 17, 2024, and titled “Ultrasound Shape Sensing”, U.S. Provisional Patent Application No. 63/664,245, filed Jun. 26, 2024, and titled “Ultrasound Shape Sensing”, and U.S. Provisional Patent Application No. 63/573,677, filed Apr. 3, 2024 and titled “Ultrasound Shape Sensing”. All of the above applications are incorporated herein by reference in their entirety.

### BACKGROUND

The ability to measure a wire's shape and deformation geometry in real time can have several important applications such as tracking soft robotic manipulator arms in space, measuring structural deformations of buildings or vehicles, or localizing surgical tools such as catheter guidewires in minimally invasive endovascular surgery. However, there are few reliable methods for estimating the shape of thin wires, and such methods usually rely on multiple expensive sensors, or are difficult to fabricate or maintain.

Shape sensing is typically accomplished by using a combination of optical techniques such as laser scanning or computed tomography (CT). However, optical techniques require an external point of view from the object being measured and cannot be used without a direct line of site, which makes them unsuitable in situations with partial information such as remote sensing. Another method for shape sensing is through the use of distributed strain sensors. However, these sensors can be bulky, require fragile electrical connections, and may have limited sensitivity.

A more recent form of distributed strain sensing involves Fiber Optic Shape Sensing (FOSS) where a fiber optic waveguide is specifically manufactured to contain several strain sensitive regions accomplished using Bragg gratings. The shape of the fiber optic waveguide can then be estimated by measuring how light interacts with these sections. However, FOSS waveguides are typically fragile, expensive to manufacture and use, and suffer from resolution limitations.

### SUMMARY

The technology described herein relates to systems and methods for sensing the shape of wires using ultrasound waves, referred to herein as ultrasound shape sensing (USS).

In one embodiment, a system comprises: a wire comprising multiple ultrasound reflection sites distributed along a longitudinal length of the wire, each of the ultrasound reflection sites comprising a surface feature that alters an acoustic impedance at the wire; an ultrasound transducer device acoustically coupled to the wire, the ultrasound transducer device configured to: generate an ultrasound wave signal that travels along the longitudinal length of the wire and partially reflects from each of the ultrasound reflection sites; and receive a reflected ultrasound waveform signal including data representative of a partial reflection of the ultrasound wave signal by each of the ultrasound reflection sites; and a processing device configured to: determine, based on the reflected ultrasound waveform signal, wire shape data of the wire; and reconstruct, based on the wire shape data, a shape of the wire.

In some implementations, determining the wire shape data of the wire comprises: predicting, using a trained model, based on the reflected ultrasound waveform signal, the wire shape data of the wire.

In some implementations, the wire shape data predicted using the trained model comprises multiple angles corresponding to multiple locations along the longitudinal length of the wire.

In some implementations, each of the multiple angles corresponds to a respective one of the ultrasound reflection sites.

In some implementations, reconstructing the shape of the wire comprises: reconstructing, using a kinematic model, based on the wire shape data predicted by the trained model, the shape of the wire.

In some implementations, determining the wire shape data of the wire comprises: determining, using an analytical model of how bending affects an ultrasound wave reflection at each of the surface features, based on the reflected ultrasound waveform signal, the wire shape data of the wire.

In some implementations, the surface features comprise a first surface feature contacting a surface of the wire with a contact force, the first surface feature made of a material having an acoustic impedance substantially similar to an acoustic impedance of a material of the wire, and the first surface feature configured to create an acoustic impedance shift that is proportional to the contact force.

In some implementations, the first surface feature is a sleeve pressed on a surface of the wire.

In some implementations, the processing device is further configured to generate a display of the reconstructed shape of the wire.

In some implementations, the wire is a guidewire of a medical instrument.

In some implementations, at least two of the surface features are circumferentially offset about a surface of the wire; and reconstructing the shape of the wire comprises: reconstructing based on the wire shape data, a three-dimensional (3D) shape of the wire.

In some implementations, the processing device is further configured to generate a display of the 3D shape of the wire that was reconstructed, the display comprising: a display of the wire from a first view; and a display of the wire from a second view substantially orthogonal to the first view.

In one embodiment, a method comprises: generating, using an ultrasound transducer acoustically coupled to a wire, an ultrasound signal that travels along a longitudinal length of the wire, the wire including multiple ultrasound reflection sites, each of the ultrasound reflection sites including a surface feature that alters an acoustic impedance at the wire; obtaining, using the ultrasound transducer, a reflected ultrasound waveform signal including data representative of a partial reflection of the ultrasound signal by each of the ultrasound reflection sites; determining, based on the reflected ultrasound waveform signal, wire shape data of the wire; and reconstructing, based on the wire shape data, a shape of the wire.

In some implementations, determining the wire shape data of the wire comprises: predicting, using a trained model, based on the reflected ultrasound waveform signal, the wire shape data of the wire.

In some implementations, the method further comprises: synchronously obtaining multiple reflected ultrasound waveform data signals and multiple images of a wire in a plurality of different wire bending positions; deriving wire shape data from the multiple images; and constructing, based on the multiple reflected ultrasound waveform data signals and the wire shape data derived from the multiple images, the trained model.

In some implementations, reconstructing the shape of the wire comprises: reconstructing, using a kinematic model, based on the wire shape data predicted by the trained model, the shape of the wire.

In some implementations, the wire is a guidewire of a medical instrument; and the method further comprises: displaying, during a medical procedure, an image of the reconstructed shape of the guidewire.

In some implementations, at least two of the surface features are circumferentially offset about a surface of the wire; reconstructing the shape of the wire comprises: reconstructing based on the wire shape data, a 3D shape of the guidewire; and displaying the image of the shape of the guidewire that was reconstructed comprises: displaying a first image of the guidewire from a first plane, and displaying a second image of the guidewire from a second plane substantially orthogonal to the first plane.

In some implementations, the method further comprises: dynamically updating, during the medical procedure, the displayed image of the reconstructed shape of the guidewire.

In some implementations, the method further comprises: acoustically coupling the ultrasound transducer to the wire.

Other features and aspects of the disclosed technology will become apparent from the following detailed description, taken in conjunction with the accompanying drawings, which illustrate, by way of example, the features in accordance with implementations of the disclosed technology. The summary is not intended to limit the scope of any inventions described herein, which are defined by the claims and equivalents.

### BRIEF DESCRIPTION OF THE DRAWINGS

The present disclosure, in accordance with one or more implementations, is described in detail with reference to the following figures. The figures are provided for purposes of illustration only and merely depict example implementations. Furthermore, it should be noted that for clarity and ease of illustration, the elements in the figures have not necessarily been drawn to scale.

FIG. 1 is a high-level diagram depicting an example system within which the technology described herein can be implemented to provide USS, in accordance with some implementations of the disclosure.

FIG. 2 schematically illustrates the operation of an ultrasound waveguide that can be made by connecting an ultrasound transducer to a wire, in accordance with some implementations of the disclosure.

FIG. 3 depicts cross-sectional view of different wires containing different surface features that can be used to perform USS, in accordance with some implementations of the disclosure.

FIG. 4A shows a side view of a surface feature including a tube placed around a wire to perform USS using amplitude modulation techniques, in accordance with some implementations of the disclosure.

FIG. 4B shows a cross-sectional view of the tube and wire of FIG. 4A.

FIG. 4C shows a cross-sectional view of the tube of FIG. 4A after the tube is crimped to contact a surface of the wire.

FIG. 4D shows a cross-sectional view of contact between the crimped tube and wire of FIG. 4C when bending the wire in a first direction.

FIG. 4E shows a cross-sectional view of contact between the crimped tube and wire of FIG. 4C when bending the wire in a second direction opposite the first direction of FIG. 4D.

FIG. 5 includes images under a microscope illustrating an example of a crimped sleeve surface applied as a surface feature on an ultrasound wire waveguide, in accordance with some implementations of the disclosure.

FIG. 6 includes a plot showing a reflected ultrasound signal from two strain sensitive surface features in a configuration employing an amplitude modulation reconstruction technique, a plot showing the reflected signal from each strain sensitive region as a function of the amount of wire bending, and a diagram schematically illustrating a possible arrangement of two surface features with different orientation sensitivities, in accordance with some implementations of the disclosure.

FIG. 7 includes an image under a microscope illustrating three examples of electroplated surface features used to encode wire shape data following phase interference techniques, in accordance with some implementations of the disclosure.

FIG. 8 is an operational flow diagram illustrating an example method that can be implemented to reconstruct a wire shape using USS, in accordance with some implementations of the disclosure.

FIG. 9 is an operational flow diagram depicting an example method of building a wire shape prediction model that maps reflected ultrasound waveform data to wire shape data, in accordance with some implementations of the disclosure.

FIG. 10 includes two images that were captured of a bending USS wire, and a plot illustrating an 8-joint kinematic model representation of the USS wire in various configurations, in accordance with some implementations of the disclosure,

FIG. 11 includes plots illustrating a comparison of USS wire angles predicted by a trained CNN to the actual angles of the ground truth shape of the USS wire, in accordance with some implementations of the disclosure.

FIG. 12 includes plots illustrating the deviation of the predicted angles shown in FIG. 11.

FIG. 13 includes plots showing a comparison of a predicted USS wire shape using a CNN model output fed into a forward kinematics model, compared with a ground truth USS wire shape observed using a camera, in accordance with some implementations of the disclosure.

FIG. 14 includes plots showing a comparison of a predicted 3D USS wire shape using a CNN model output fed into a forward kinematics model, compared with an observed ground truth 3D USS wire shape, in accordance with some implementations of the disclosure.

The figures are not exhaustive and do not limit the present disclosure to the precise form disclosed.

### DETAILED DESCRIPTION

The technology described herein is directed to systems and methods for sensing the shape of wires using ultrasound waves, referred to herein as USS. In accordance with the technology described herein, an ultrasound transducer is coupled to a wire such that the wire acts as an ultrasound waveguide. Reflected ultrasonic waves within the wire are identified by an ultrasound sensor. Ultrasound waves travel down the length of the wire until they reach an area with a different acoustic impedance. The waves reflect from such areas in proportion to the change in acoustic impedance. As such, the reflected ultrasound waveform collected using the ultrasound sensor encodes shape information that can be used to reconstruct the 3D shape of the wire. In accordance with the systems and methods described herein, this phenomenon is exploited by slightly altering the surface composition of the wire, creating unique ultrasound reflection features along the length of the wire that change predictably as the shape of the wire changes.

Some implementations of the disclosure leverage machine learning to reconstruct the shape of the wire based on the reflected ultrasound waveform. The interference of multiple surface features as well as the difficult to characterize physics of the relationship between strain and reflected ultrasound waveforms can make reconstructing the wire shape based on the reflected ultrasound waveform a complex inverse problem. As further described herein, a model can be trained to reliably map the reflected ultrasound waveform to wire shape data.

Various advantages can be realized by implementing the technology described herein. By virtue of using an ultrasound waveguide, the USS technology described herein can be implemented at a low cost and complexity (e.g., using a single ultrasound transducer/receiver) as contrasted with some prior techniques for shape sensing (e.g., FOSS), while achieving accurate wire shape prediction in real-time. In addition, by virtue of leveraging a trained model that maps ultrasound waveforms directly to wire shape, the complex characterization of the physics of the relationship between strain and reflected ultrasound waveforms can be avoided. Further still, embedding the ultrasonic waveguides described herein into flexible and moving components opens the possibility for various new applications such as the localization of catheters and guidewires in medical applications, the development of soft proprioceptive robots, as well as navigation and guidance of cameras to out-of-reach areas. These and other advantages that can be realized by implementing the technology described herein are further exemplified by the description that follows.

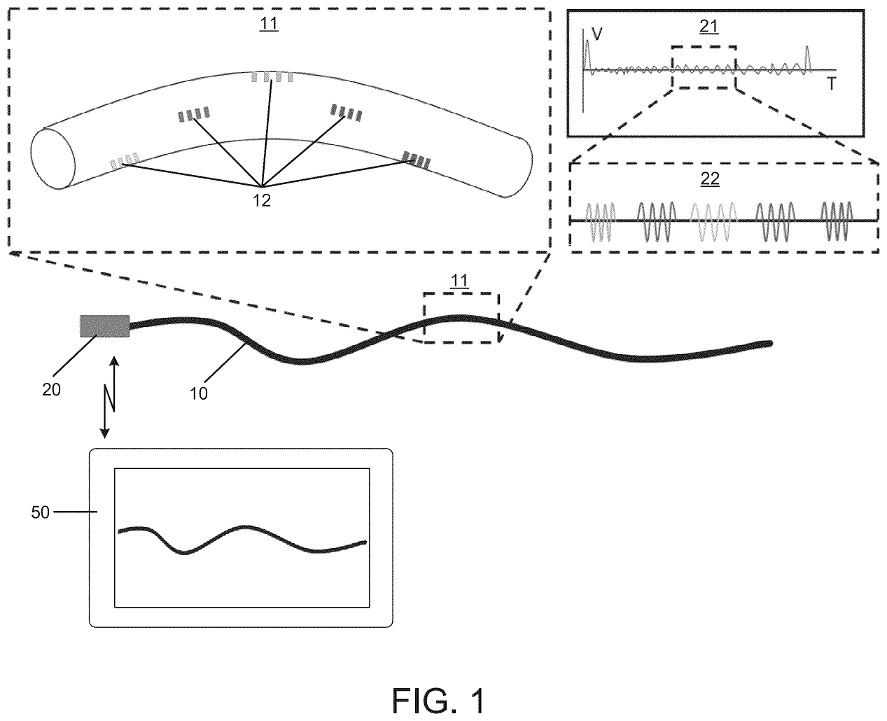

FIG. 1 is a high-level diagram depicting an example system within which the technology described herein can be implemented to provide USS, in accordance with some implementations of the disclosure. As depicted, the system includes an ultrasound transducer device 20 acoustically coupled to a wire 10 such that the wire acts as an ultrasound waveguide. The system also includes a wire shape reconstruction device 50 in communication with ultrasound transducer 20.

Wire 10 can have multiple reflective sites 11 along its length that are strain or bending sensitive. Each reflective site can contain one or more surface features 12 that change acoustic impedance and create ultrasound reflection sites in the wire waveguide. Local bending/strain can affect each of these surface features 12. In operation, an ultrasound transducer of ultrasound transducer device 20 is configured to generate an ultrasound wave signal 21 (e.g., pulse) that travels down the length of wire 10 and partially reflects from each reflective site 11. The ultrasound wave can reflect from each reflective site 11 in proportion to the change in acoustic impedance. The reflected ultrasound waves/pulses 22 encode wire shape information (e.g., strain or bend) of each reflective site 11 that is carried back to the ultrasound transducer 20 and recorded. Recorded signals can be analyzed by wire shape reconstruction device 50 to compute the shape of the shape sensitive wire.

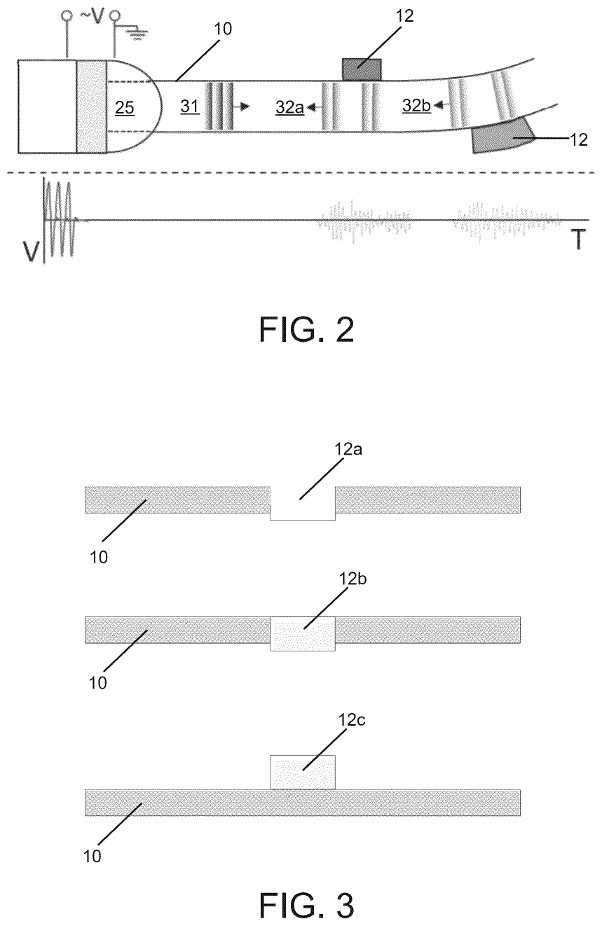

FIG. 2 schematically illustrates the operation of an ultrasound waveguide that can be made by connecting an ultrasound transducer 25 of ultrasound transducer device 20 to wire 10, in accordance with some implementations of the disclosure. As depicted by FIG. 2, ultrasound waves can be sent in short pulses 31 by ultrasound transducer 25, and a reflected wave 32a occurs at a surface feature 12. When a surface feature 12 is deformed by bending the wire 10, the reflected wave 32b changes can be measured. The surface features 12 can compress or stretch depending on whether they are on the inner or outer surface of the wire's bend. As such, the bending wire 10 can change how the signal is reflected from the surface feature 12, and the returning reflections can be analyzed to measure how much the wire 10 has bent, or analogously, the wire's local strain. As further described below, by measuring the reflection shift for several surface features 12 spaced along the length of the wire 10, the local strains or angles at several points along the wire can be calculated and the shape of the wire 10 can be estimated.

Wire 10 can be made of any suitably elastic material that returns to shape after being bent or strained. For example, wire 10 can be formed of metals or metal alloys such as stainless steel, titanium, nickel-titanium, and the like. Wire 10 could also be formed of non-metallic materials such as polymers or ceramics, particularly those that are flexible and suitable for use as ultrasound waveguides. In some implementations, the diameter of wire 10 can be anywhere between about .1 mm and 150 mm. It should be appreciated that the material and diameter of wire 10 can be specifically adapted to a USS application. For example, in implementations where wire 10 is implemented as a medical guidewire, the diameter of wire 10 can be about 1 mm or less, and it can be made of a material such as stainless steel or nickel-titanium.

As depicted by FIG. 3, which shows cross-sectional views of different wires 10 containing surface features, the surface features 12 that change acoustic impedance can take the form of notches 12a in the wire 10, a material 12b added inside the wire 10, or a material 12c added on the surface of the wire. The surface features can be made of the same type of material or a different type of material as wire 10. In some implementations, a combination of different types of surface features can be used. Surface features 12 can be distributed along the longitudinal length of wire 10 to enable prediction of wire bend/strain along different points of wire 10. The number of surface features incorporated on or inside the wire can be varied depending on the length of the wire, a target accuracy of the USS application, and/or any computer processing limitations in relation to predicting the final wire shape. For example, increasing the number of surface features 12 can enable a more accurate prediction of the final wire shape but increase the complexity and processing requirements for predicting the final shape as more reflected ultrasound waveforms are convolved with the received signal. Surface features 12 can be distributed equidistantly or not equidistantly along the length of wire 10. In implementations where USS of the wire 10 occurs in three dimensions, surface features can be circumferentially offset in addition to being longitudinally spaced. For example, as depicted in the particular illustration of FIG. 1, in addition to being longitudinally spaced, surface features 12 are offset about 90 degrees about the circumference of wire 10. In such implementations, surface features need not be circumferentially offset by the same amount. For example, some adjacent surface features 12 can be offset by 90 degrees while others are offset by 45 degrees.

The ultrasound transducer device 20 can be any device configured to excite longitudinal ultrasound waves in a wire 10 that is acoustically coupled to it and measure the reflected ultrasound waves. For example, the ultrasound transducer device 20 can be an ultrasonic pulser-receiver that includes a pulser-receiver and transducer. The pulser section can be configured to generate pulses of energy that are converted into ultrasonic pulses when applied to the ultrasonic transducer. The receiver section can be configured to amplify the voltage signals produced by the transducer, which are representative of the ultrasonic pulses that are received. In some implementations, the ultrasound transducer 25 can be a piezoelectric transducer such as a piezoelectric disk. In other implementations, the ultrasound transducer 25 can use some other technology (e.g., capacitive transducer) for generating and detecting ultrasound waves in wire 10.

As depicted in the example of FIG. 1, a single ultrasound transducer device 20 can be acoustically coupled to an end of wire 10 to create an ultrasound waveguide and perform USS using the reflected ultrasound waveform collected at ultrasound transducer device 20. By virtue of this configuration, the USS system can be simplified in cost and overall complexity. In alternative implementations, multiple ultrasound transducers could be acoustically coupled to wire 10 to perform USS. For example, a respective ultrasound sensor could be positioned to collect a reflected ultrasound signal generated from a respective reflective site 11 or multiple respective reflective sites 11. Such implementations may reduce the difficulty in extracting an ultrasound signal reflected from a respective as the signal would no longer be convolved with other reflected signals or convolved with fewer reflected signals, at the cost of a more complex and costly hardware arrangement.

Wire shape reconstruction device 50 is configured to compute the shape of the wire 10 based on the reflected ultrasound waveform signal data collected by ultrasound transducer device 20. To this end, wire shape reconstruction device 50 is configured to map the reflected ultrasound waveform signal data to wire shape data that represents the shape of the wire. In some implementations, further described below, a machine learning model can be trained to predict the strain or bend (e.g., bend angle) of each reflective site 11 containing a surface feature 12 given reflected ultrasound waveform data as an input. The strain/bending predictions predicted by the machine learning model can subsequently be fused to calculate/estimate the shape of the wire based on either solid mechanical models or data-driven approaches. In some implementations, wire shape reconstruction device 50 can also be configured to train the model used to map the reflected ultrasound waveform signal data to wire shape data that represents the shape of the wire. Alternatively, some other device can be used to train the model before it is used in USS applications by shape reconstruction device 50. Particular techniques for training and applying such models are further described below.

The reflected ultrasound waveform data can be communicated from ultrasound transducer device 20 to wire shape reconstruction device 50 via a wired or a wireless communication link. For example, a radio frequency link such as a Bluetooth® link or a Wi-Fi® link can be used to communicate the data.

In this particular example, wire shape reconstruction device 50 is illustrated as a mobile device in communication with ultrasound transducer 20. The mobile device can be a tablet, laptop, a smartphone, a head mounted display (HMD), or other suitable mobile device configured to generate the reconstructed wire shape. In other implementations, a desktop computer or other device can be implemented as wire shape reconstruction device 50. In yet other implementations, wire shape reconstruction device 50 and ultrasound transducer 20 can be integrated as part of the same device that performs the hardware and software functions of both devices. In a particular implementation, the wire shape reconstruction device 50 can run an application for performing wire shape reconstruction. The application can be configured to display the wire shape estimated based on the reflected ultrasound waveform data received from ultrasound transducer 20. The display can be provided in real-time to an operator of a USS system. For example, in implementations where wire 10 is a medical guidewire, the displayed wire shape can be used to aid a physician in a medical procedure. The application can also be configured to display other pertinent data such as the underlying waveform data and wire shape bending data estimated from the reflected ultrasound waveform data (e.g., estimated bending angles).

Many applications can be realized using the USS techniques described herein. For example, in one particular application, a catheter guidewire system configured with the USS technology described herein could be used in place of X-rays or other more expensive, invasive, and/or complicated medical imaging modalities typically used in conjunction with medical guidewires to navigate a patient's cardiovascular system and position the catheter with precision. In some implementations, the USS techniques described herein could be used in robotic applications, such as developing motors to provide position feedback via the shape sensing wire without requiring additional feedback mechanisms. In some implementations, the USS techniques described herein could be used in civil engineering applications such as placing wires in the column of buildings to measure the deflection of large-scale structures.

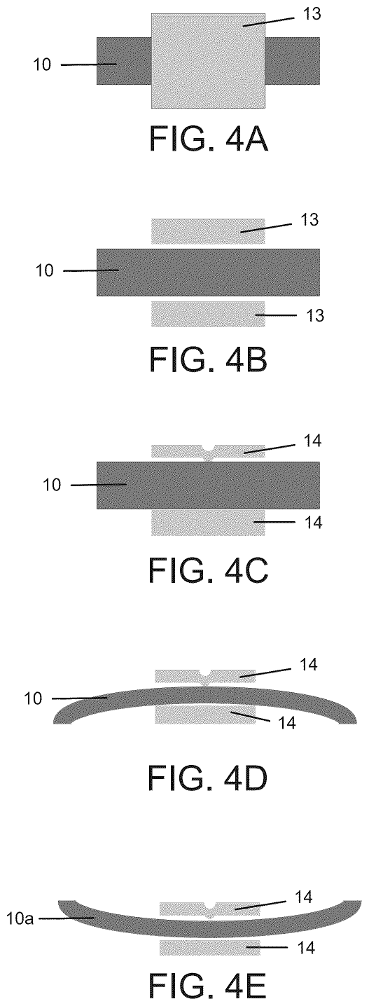

As alluded to above, USS can be accomplished by extracting wire shape data from the reflected ultrasound waves received from the reflection sites distributed along the length of the wire waveguide. As such, the surface features of the reflection sites of the wire waveguide can be configured such that the ultrasound echoes encode wire shape data. In some implementations, the surface features applied to the wire waveguide can be designed following amplitude modulation techniques such that ultrasound echoes encode wire shape data. In such implementations, the surface acoustic impedance of the ultrasonic waveguide can be changed by using a surface feature that contacts the wire surface and is made of a material with an acoustic impedance similar to that of the waveguide. In such implementations, the magnitude of the surface impedance shift will directly correlate to the contact force between the waveguide and the material. Therefore, the magnitude of the amplitude of the returning ultrasound echoes can be modulated by changing the contact force. This phenomenon can be used to create sensitive surface reflectors that encode information of the shape of the waveguide into the reflected ultrasound echoes. FIGS. 4A-4E illustrate one such example implementation of a surface feature.

As depicted by FIG. 4A, which shows a side view, and FIG. 4B, which shows a cross-sectional view, a short segment of a hollow tube 13 of larger diameter than the wire 10 can be placed around the wire waveguide. The tube can me made of a material having an acoustic impedance similar to the waveguide (e.g., both tube and waveguide can made of steel). As depicted by FIG. 4C, which shows a cross-sectional view, a kink can be created in the middle of the hollow tube 13 tube such that it contacts the waveguide by crimping it in the middle to form crimped tube 14. The contact between the crimped tube 14 and the waveguide creates a change in the surface acoustic impedance of the waveguide and reflects ultrasound waves from the location of contact. The crimping of the surrounding tube can create three fixed points of contact. When the waveguide is bent in place with these three points the contact force of the crimped tube 14 on the waveguide will change. It can press into these three points and increase the contact force, thus increasing the amplitude of the reflection (FIG. 4D), or it can bend away from these points, reducing the contact force, and therefore reducing the amplitude of the reflection (FIG. 4E).

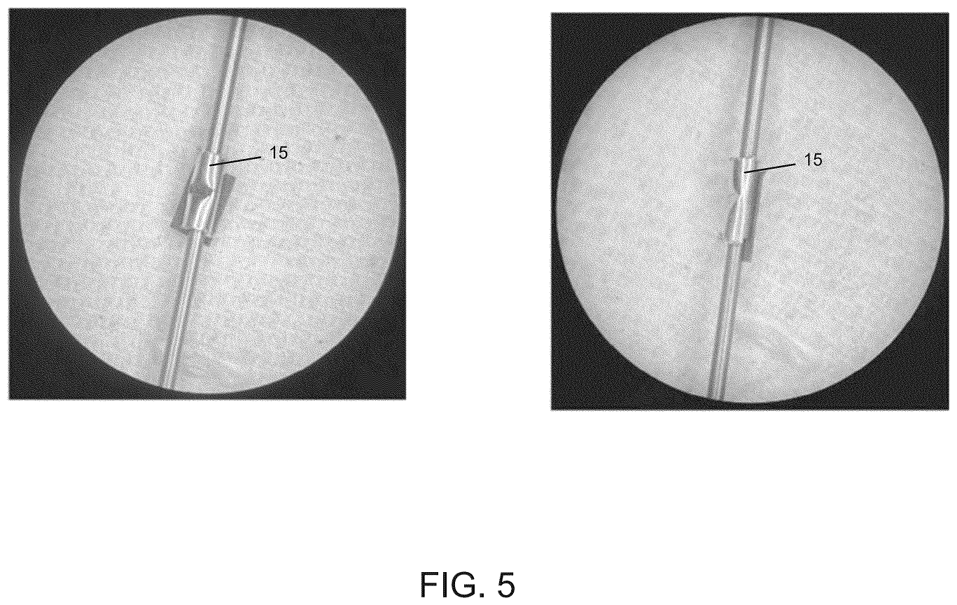

FIG. 5 includes images under a microscope illustrating an example of a crimped tube/sleeve 15 applied as a surface feature on a French wire, in accordance with some implementations of the disclosure.

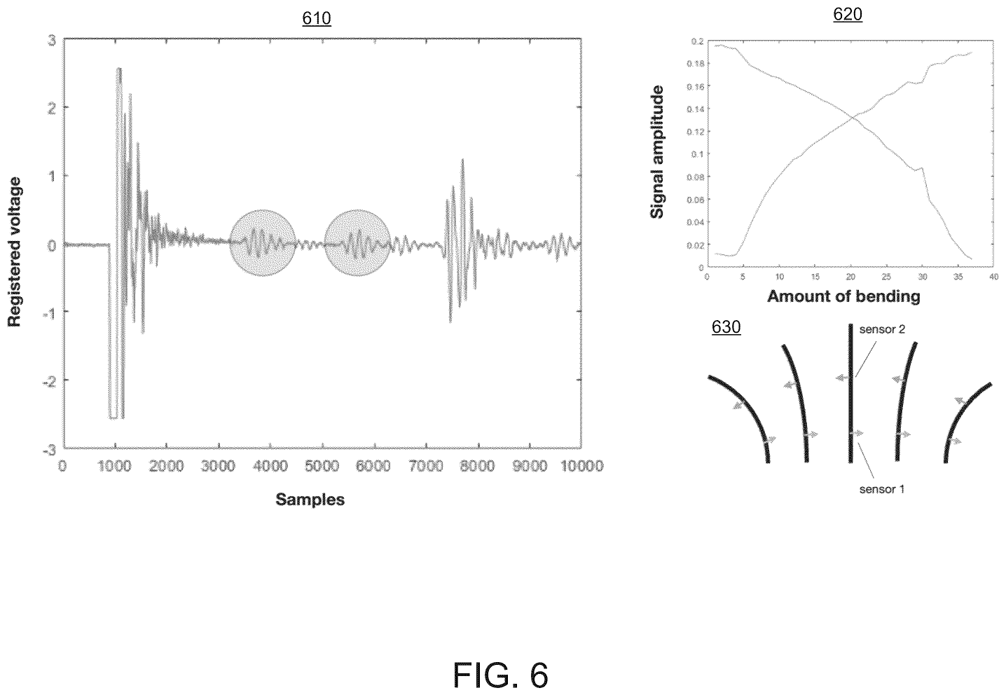

FIG. 6 includes a plot 610 showing a reflected ultrasound signal from two strain sensitive surface features in a configuration employing an amplitude modulation reconstruction technique, a plot 620 showing the reflected signal from each strain sensitive region as a function of the amount of wire bending, and a diagram 630 schematically illustrating a possible arrangement of two surface features with different orientation sensitivities, in accordance with some implementations of the disclosure. Two bumps in plot 610 denote the strain sensitive regions. As depicted by plot 620, as wire is bent from left to right, the signal amplitude from one sensor decreases as the other increases.

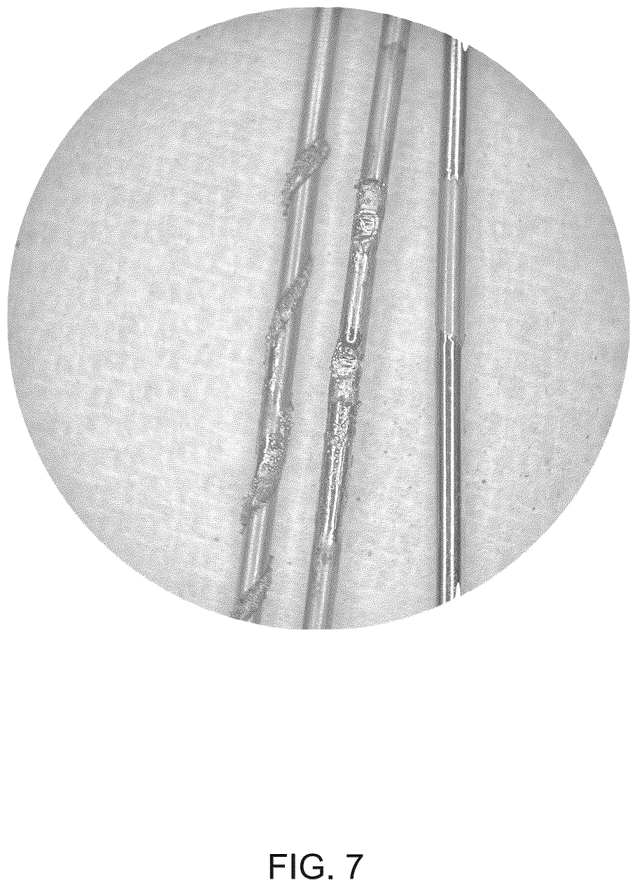

In other implementations, the surface features applied to the wire waveguide can be designed following phase interference techniques to encode wire shape data in the reflected ultrasound echoes. In such implementations, a different material can be deposited on the surface of the ultrasound waveguide to create an area of different surface acoustic impedance. If the length of the deposit is of a finite length, then two wave reflections can be created, one from the leading edge of the deposit and one from the trailing edge (when referenced to the propagation direction of the initial ultrasound packet). Depending on the length of the surface deposit and the frequency of the incoming ultrasound packet, the leading and trailing edge reflection can interfere with each other. When the waveguide is strained, the surface deposit can deform as well, changing the distance between the leading and trailing edge and thus changing the interference pattern of the reflected ultrasound waves. In some implementations, these surface features can be applied by melting solder onto the surface of the waveguide or via electroplating. FIG. 7 includes an image under a microscope illustrating three examples of electroplated surface features used to encode wire shape data following phase interference techniques, in accordance with some implementations of the disclosure. As depicted, wires can be electroplated with patterns such as spirals, circumferential notches,

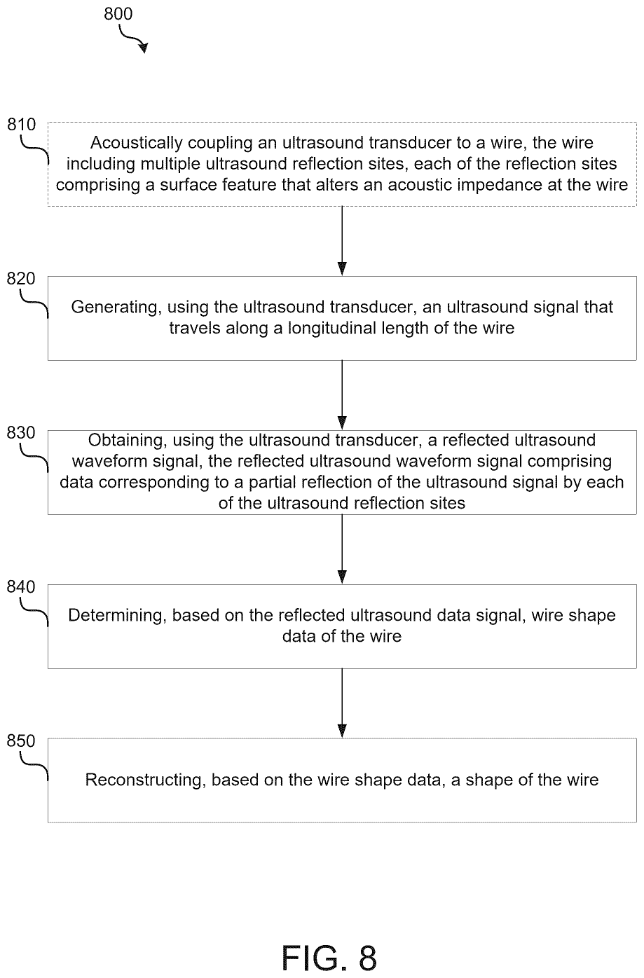

FIG. 8 is an operational flow diagram illustrating an example method 800 that can be implemented to reconstruct a wire shape using USS, in accordance with some implementations of the disclosure. The USS system depicted in FIG. 1 can be used to perform method 800. In some implementations, operations 840-850 of method 800 can be performed by wire shape reconstruction device 50 in response to executing, using a processing device, instructions stored in a computer readable medium.

Optional operation 810 includes acoustically coupling an ultrasound transducer to a wire, the wire including multiple ultrasound reflection sites, each of the reflection sites comprising a surface feature that alters an acoustic impedance at the wire. The transducer can be acoustically coupled to a first end of the wire such that it can excite longitudinal ultrasound waves in the wire and measure ultrasound waves reflected from the reflection sites of the wire. In some implementations, acoustic coupling can occur by forming a fixed physical connection between the transducer and wire (e.g., via soldering) or a removable physical connection (e.g., removably coupling an end of the wire to the transducer). In some implementations, acoustic coupling can occur without a direct physical connection between the components. In some implementations, the USS system may be preconfigured such that an ultrasound transducer is already acoustically coupled to a wire. In such implementations, operation 810 can be skipped.

Operation 820 includes generating, using the ultrasound transducer, an ultrasound signal that travels along a longitudinal length of the wire.

Operation 830 includes obtaining, using the ultrasound transducer, a reflected ultrasound waveform signal, the reflected ultrasound waveform signal comprising data corresponding to a partial reflection of the ultrasound signal by each of the ultrasound reflection sites. In some implementations, the reflected ultrasound waveform can be saved as a voltage versus time series of datapoints.

Operation 840 includes determining, based on the reflected ultrasound data signal, wire shape data of the wire. The wire shape data can represent an amount of bending or strain in different locations of the wire. In some implementations, the wire shape data can represent an amount of bending or strain of each surface feature of each ultrasound reflection site. However, as further described below, it should be appreciated that there need not necessarily be a one-to-one mapping between the determined wire shape data and the number of surface features. In some implementations, the wire shape data can be represented as a collection of angles. In some implementations, a trained model that predicts wire strain or bend for different locations of the wire based on a reflected ultrasound waveform can be used to predict wire shape data. As further described below, the model can be trained to learn a mapping between wire shape and reflected ultrasound patterns with data collected using an experimental calibration rig that deforms test wires and collects the reflected signal as well as the ground-truth wire deformation. In some implementations, the trained model could also predict the uncertainty in its own estimates, using a probabilistic approach. In particular implementations, a neural network model such as a Convolutional Neural Network (CNN) or Feedforward Neural Network can be trained and used to decode the ultrasound waveforms and output shape data. In some implementations, a Transformer neural network architecture can be used. Using a trained model to predict wire shape data from the reflected ultrasound data signal may be particularly advantageous as the interference of multiple surface features as well as the difficult to characterize physics of the relationship between strain and reflected ultrasound waveforms make reconstructing the wire shape based on the reflected ultrasound waveform a complex inverse problem. By contrast, in recent years machine learning has demonstrated strong results in identifying complex patterns from high dimensional data.

In other implementations, wire shape data for each of the ultrasound reflection sites could be extracted from the reflected ultrasound data signal using an analytical model of how the bending or strain influences the reflections of each surface feature. The created analytical model could assume that each surface feature will produce a wave reflection and that the magnitude of its reflection will correspond with the amount of bending that the surface feature is being subjected to. In such an analytical model, the position each surface feature on the wire can be a known parameter that allows creation of a linear superposition of all of their contributions. In particular, the reflected ultrasound signal could be approximated by a linear superposition of wavelets, each with a unique amplitude. Each specific amplitude, and therefore bending, of each surface feature, could be solved for by minimizing the difference between the approximated signal and the measured signal. In some implementations, least squares methods could be applied to fit wavelets to wire shape. It should be noted that the complexity of analytical approaches can increase with the number of surface features. In other implementations, Fourier Transforms and/or Wavelet Transforms could be used to infer the strain at each strain-sensitive region.

Operation 850 includes reconstructing, based on the wire shape data, a shape of the wire. The wire shape data (e.g., strain/bending predictions predicted by a machine learning model) obtained at operation 840 can be fused to estimate the shape of the wire based on solid mechanical models or data-driven approaches. In particular implementations, predicted angles can be fed into a forward kinematics model to produce an overall shape of the USS wire.

In some implementations, method 800 can be performed to determine a 3D shape of the USS wire. In such implementations, a number of joints on the kinematic linkage can be doubled, and each second joint can be interpreted as an out-of-plane strain sensor. In such implementations, the predicted wire shape data can include wire shape corresponding to two planes. For example, the overall shape of the USS wire can be provided from two views—a top view and a side view.

### Training

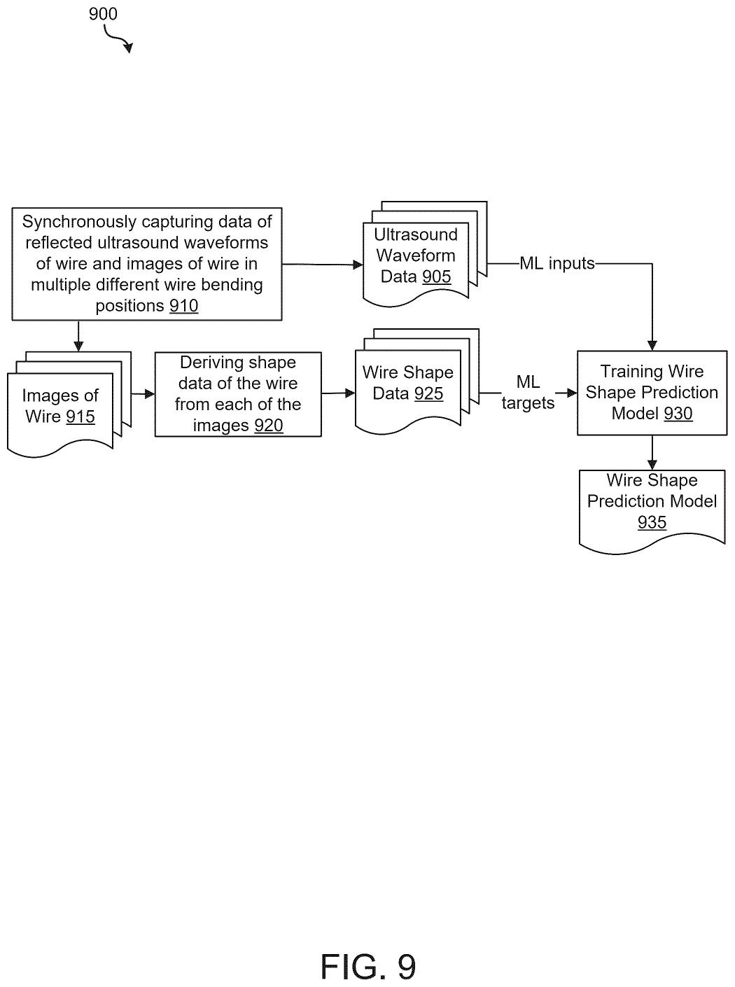

FIG. 9 is an operational flow diagram depicting an example method 900 of building a wire shape prediction model 935 that maps reflected ultrasound waveform data to wire shape data, in accordance with some implementations of the disclosure. For example, the wire shape prediction model can be trained to learn the mapping expressed by formula (1):

$$Θ = f ( W ) \qquad ( 1 )$$

Where Θ is a representation of wire shape (e.g. a collection of angles), and W is a collection of ultrasound waveforms. In implementations, method 900 can be implemented in a system including the USS wire, a high-speed camera or other imaging device, an ultrasound transducer device such as a pulser-receiver device that is acoustically coupled to the USS wire, and a data acquisition and model building device such as a desktop or mobile computer.

Operation 910 includes synchronously capturing data 905 of reflected ultrasound waveforms of an USS wire and images 915 of the wire in multiple different wire bending positions. To this end, the imaging device can capture images of a strain/bend sensitive USS wire with multiple ultrasound reflection sites/surface features as described in the disclosure. During data acquisition, the USS wire can be manually or machine bent in several different configurations. To ensure robust training data, as many strain configurations of the USS wire as possible can be captured. To synchronize data collection, during image capture the imaging device can trigger the ultrasound transducer device. For example, during each image frame, the camera can trigger a pulser-receiver device to generate an ultrasound signal that is partially reflected by the surface features of the wire. In some implementations, ultrasound waveform data 905 corresponding to the USS wire bent in a variety of different positions can initially be buffered in a memory of the ultrasound transducer device. For example, once the buffer is full, the ultrasound waveform data 905 of the wire and images of the wire 915 can be transferred to a data acquisition and model building device (computer) to complete one data acquisition cycle. Multiple data acquisition cycles can be implemented to ensure robust training data. For example, at least thousands of shape-waveform data pairs can be captured. During image capture, the USS can be superposed on a white background to facilitate shape data extraction at operation 920.

Operation 920 includes deriving shape data 925 of the wire from each of the images. For example, the finally derived shape data 925 of the wire can be a set of bending angles associated with the wire. The number of bending angles can be the same as or different from the number of surface features. To this end, initial USS wire shape positions can be extracted by applying a grayscale mask to the images to identify pixels/points corresponding to the wire. A high order polynomial can be fit to the wire points extracted from the images to obtain a smooth set of points representing the wire shape. To reduce the dimensionality of the prediction task, a kinematic model can be used to convert the smooth point data to joint angles representing actual wire shape. The number of joint angles representing the wire shape data can be the same as or similar to the number of actual surface features on the wire.

Operation 930 includes training the wire shape prediction model 935 based on a training dataset including an input dataset and a target dataset. The input training dataset can include at least some of the ultrasound waveform data. The target training dataset may include at least some of the wire shape data 925. In this case, the model 935 can be trained to extract features from an input reflected ultrasound waveform data signal of an USS wire and output a target prediction of wire shape data (e.g. angles) corresponding to the wire. The wire shape prediction model 935 can also output a confidence score associated with each prediction. It should be noted that while the shape data (e.g., angles) predicted by the model can be the same as the number of ultrasound reflection sites/surface features and correspond to these surface features, there does not need to be a one-to-one correspondence between the predicted shape data and the surface features. For example, while in some implementations a trained model can output a prediction including six angles corresponding to the six surface feature sites of a wire, in other implementations the model may output a prediction including fewer than six angles or more than six angles. In some implementations, a model can be trained to predict shape data for a USS wire having a specific number of surface features. In other implementations, a more generalized model can be trained to predict shape data for different USS wires that can have different numbers of surface features.

In particular implementations, a neural network model such as a CNN can be used to decode ultrasound waveforms and output shape data. These neural networks have proven effective for time series regression or classification tasks, as they circumvent the need for manually extracting features.

In some implementations, wire shape prediction model 930 can be configured to output a target prediction of wire shape data (e.g. angles) corresponding to the wire in 3D. In such implementations, the camera/image capture system can be replaced by a motion capture system that is triggered by the ultrasound transducer device and collects shape data directly from the wire shape as it is moved in space. The predicted angles can correspond to two different planes of USS wire. For example, the predicted angles can be used to form a top view and side view of the USS wire.

### Experimental Results

Particular applications of the systems and methods described herein to perform USS, including using a trained CNN model to predict wire shape data, and their associated results are described below. It should be appreciated that the forthcoming discussion describes some particular example implementations and that one having skill in the art would understand alternative implementations of the technology can be implemented in view of the disclosure.

Thin wires with a diameter of 1.35 mm and a length of about 1 meter were used to create ultrasound waveguides. Piezoelectric disks with a resonant frequency of 300 KHz were acoustically coupled to one end of the wire. Acoustic coupling was accomplished by depositing a thin layer of tin solder on the wire end and by creating a large drop (radius of 1 cm) of solder on the piezoelectric disk. The wire tip was then inserted into the molten solder and allowed to cool. In some cases, a backing made with heat set adhesive was applied to the other side of the piezoelectric disk to dampen the vibration of the piezoelectric disk and create shorter ultrasound pulses.

Typically, an ultrasound wave packet will propagate down the length of the waveguide until it reaches an area of altered surface acoustic impedance. The change in acoustic impedance would then causes a portion of the packet to be reflected back toward the piezoelectric transducer. Ultrasound waves were excited and returning echoes were recorded using a pulser receiver. The pulser receiver operated in the following manner. First, it would send a negative voltage spike to the piezoelectric disk on the waveguide. The large voltage change caused the piezoelectric disk to physically deform and produce an acoustic wave in the wire that was acoustically coupled to it. The piezoelectric disk was specifically chosen to excite only longitudinal ultrasound waves. Furthermore, a large voltage spike would cause the piezoelectric disk to vibrate at its resonant frequency. This vibration would decay over a short time creating a short-wave packet with a duration of 20 microseconds. The resulting ultrasound wave packet would then propagate down the waveguide wire, and partial wave packets would reflect from any area where the waveguide's acoustic impedance changed, such as sections of the waveguide where a thin layer of metal was deposited. By contrast, for a bare waveguide, reflected wave packets would reflect from the end of the waveguide wire where the metal transitions to air, causing a large impedance mismatch. The pulser receiver was set to “pulse echo” mode. This causes the pulser receiver to use the same piezoelectric disk that created the ultrasound wave packet as a sensor to measure the returning ultrasound reflections. The returning signals were then amplified and analyzed.

Data of the reflected ultrasound waveforms and images of the wire were collected simultaneously. During data collection, a camera triggered the pulser/receiver at 200 Hz with a 5V positive square wave trigger. The ultrasound reflected from the guidewire was stored in the memory buffer of the oscilloscope. Faster data acquisition would result in overlap of the signal due to transmission time of the ultrasound through the guidewire. Once the oscilloscope buffer was full the ultrasound waveforms and camera images were transferred to a computer. Taking into account the USB transfer rate results in a data acquisition rate of ≃5600 data points per minute. During data collection the USS wire was hand strained. An explicit effort was made to cover as many possible strain configurations as possible, ensuring the training data set was sufficiently rich for successful learning.

A high frame rate Motion Pro Y7 camera was used to capture top-down images of the USS wire moving and bending on an optical table. The USS wire was superposed on a white background allowing the USS wire positions to be extracted by a simple background-foreground extraction method. This was based on a custom algorithm which proceeded as follows. First, a GrayIm2Maskfunction was called. This function thresholds the grayscale image at a value thresh and returns all values below the threshold. Second, a MaskedImage2points was called. This function searches the masked image and identifies all the pixels that passed the previous threshold. This then places the pixels which are on the wire in a wire points array (x, \hat{p}_{y}(x)). Thereafter a 5th order polynomial was fit to the wire points extracted from the images to obtain a smooth set of points (x, p_{y}(x)).

Each waveform acquired and the corresponding images of the wire shape were stored in data arrays W and Y, respectively. The W array consisted of the ultrasound waveform information stacked for each image of the USS wire. The resulting shape was W∈R^{N×d}^{_{w}}, where d_{w} is approximately 1000-2000 and N are the number of acquired training samples. The Y array contained the p_{y}(x) information, i.e., the y position of the USS wire for each x position of the image. To reduce the dimensionality of the prediction task, the USS wire as represented as a set of rigid links connected by revolute joints. For the sensorized portion of the USS wire, which was around 30 cm long, 8 joints were used.

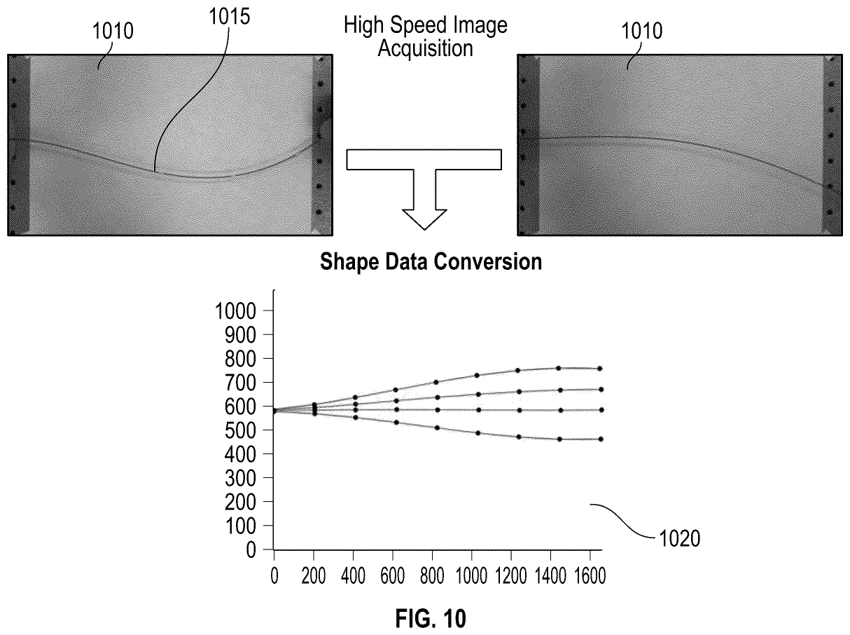

The expressivity of the resulting kinematic model is illustrated by FIG. 10, which includes two highspeed images 1010 that were captured of a bending USS wire 1015, and a plot 1020 illustrating an 8-joint kinematic model representation of the USS wire in various configurations, in accordance with some implementations of the disclosure. As shown in the example illustrated by FIG. 10, the highspeed images were used to train the CNN and as ground truth data to validate the CNN. In this example, these images were processed, and 8 equidistant points were positioned along the length of the wire. The relative angles between these points were computed and used to make the 8-joint kinematic model in various configurations.

Dimensionality was reduced by fitting the n-joint kinematic model to the Y position data. The goal was to extract the nⱼₒᵢₙₜₛ angles that most closely represent the actual wire shape using the rigid link kinematic model. To this end, the following process was followed. First, the USS wire was split into nⱼₒᵢₙₜₛ equal segments of length

$$a = \frac{L}{{n}_{j o i n t s}} .$$

Second, the arclength was obtained as a function of x-position using formula (2):

$$s ( x ) = {\int }_{0}^{x} \sqrt{1 + {( \frac{d y}{d x} )}^{2}} d x \qquad ( 2 )$$

Thereafter, a set of query points x_{q}ⁱ, i∈{1, . . . , nⱼₒᵢₙₜₛ} was obtained by calculating everywhere where s(x)>nα, n∈{1, . . . , nⱼₒᵢₙₜₛ}. At each query point x_{q}, the best fit angle was obtained using formula (3):

$${θ}_{q} = - arc tan [ \frac{{p}_{y} ( {x}_{q}^{i + 1} ) - {p}_{y} ( {x}_{q}^{i} )}{{x}_{q}^{i + 1} - {x}_{q}^{i}} ] , ∀ q ∈ \{ 1 , … , {n}_{j o i n t s} \} \qquad ( 3 )$$

Following this procedure, a dataset consisting of the original waveform matrix W∈ [symbol] ^{N×d}^{_{w}} and shape matrix Θ∈ [symbol] ^{N×n}^{ⱼₒᵢₙₜₛ} was obtained.

A CNN was used for shape data prediction. The architecture consisted of three convolutional layers of sizes [1024, 512, 256] with kernel size 3 and stride 1, followed by a regression head, i.e. a fully connected layer that maps the 256-dimensional latent space down to the nⱼₒᵢₙₜₛ angles of the output space. Between each convolutional layer a batch-normalization layer was included to address the problem of internal covariate shift. Both the input data W and the output data Θ were standardized to zero mean, unit variance. The following were used: a learning rate of 5×10⁻⁴, a batch size of 128, and a train validation split of 20%. The dataset consisted of 4000 total samples, and the model was trained for 1500 epochs. The model was trained until the validation loss reached a reasonable convergence.

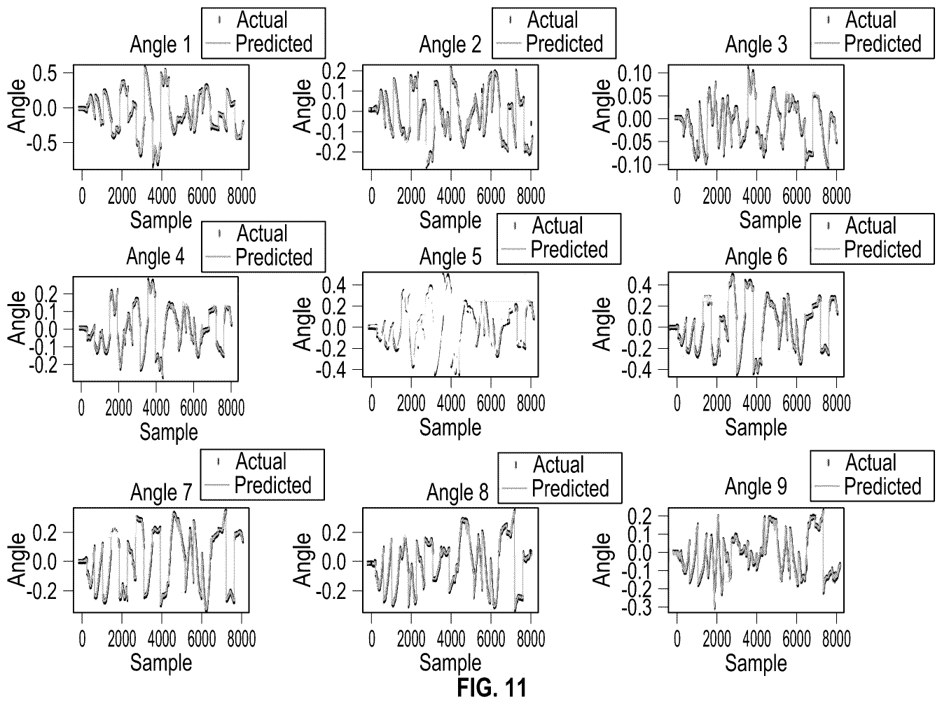

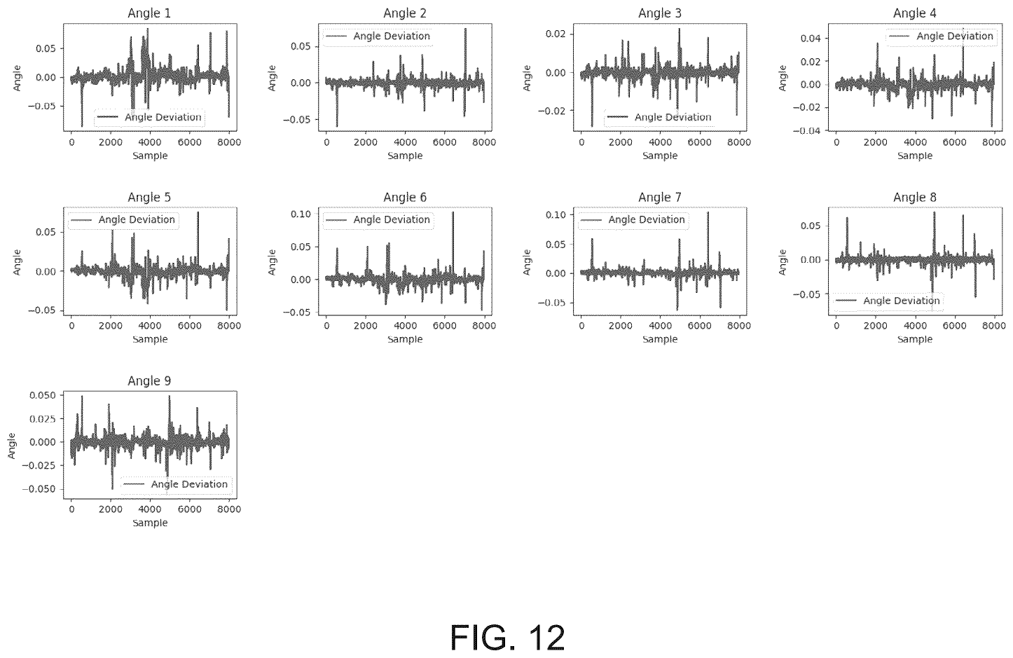

FIG. 11 includes plots illustrating a comparison of angles predicted by the trained CNN to the actual angles of the ground truth shape of the USS wire in the dataset, in accordance with some implementations of the disclosure. As depicted, the predicted angle values (light gray) closely followed the actual angle values. This is further illustrated by FIG. 12, which includes plots illustrating the deviation of the predicted angles shown in FIG. 11.

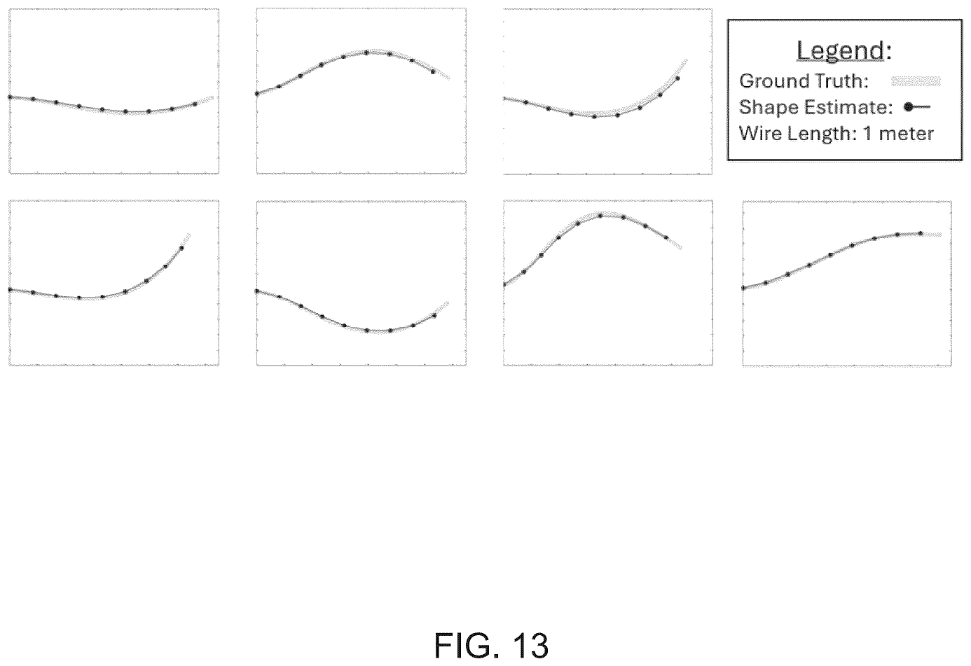

The predicted angles from the CNN model were fed into a forward kinematics model that produces an overall, predicted shape of the USS wire. FIG. 13 includes plots showing a comparison of the predicted USS wire shape using the CNN model output fed into a forward kinematics model, compared with the ground truth USS wire shape observed using the camera, in accordance with some implementations of the disclosure. As illustrated, the predicted shape closely agrees with the ground truth shape.

The same techniques for shape inversion were applied in the 3D case, including using the CNN model to predict shape data in the 3D case, and using a forward kinematics model to produce a 3D predicted shape of the USS wire. In the 3D case, the number of joints on the kinematic linkage was doubled and each joint was interpreted as an out-of-plane strain sensor. In the 3D case, the CNN mapped the raw ultrasound waveform to angles corresponding to 3D strains along the wire. The camera system was replaced by a motion capture system that was triggered by the pulser receiver and collected shape data directly from the wire shape as it moved in space. The waveforms were stored using the previously described techniques.

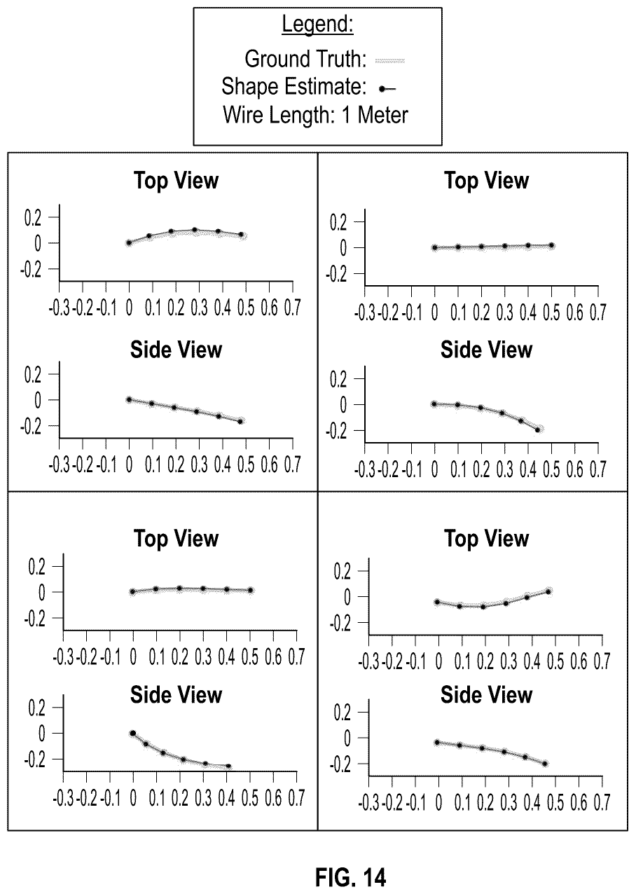

A comparison of angles predicted by the trained CNN to the actual angles of the ground truth shape of the USS wire in the dataset in the 3D case was made. It was observed that the predictions of the angles over the validation data set showed excellent agreement, validating the method for the 3D case. The predicted angles from the CNN model in the 3D case were fed into a forward kinematics model that produces an overall, 3D predicted shape of the USS wire. FIG. 14 includes plots showing a comparison of the predicted 3D USS wire shape using the CNN model output fed into a forward kinematics model, compared with the observed ground truth 3D USS wire shape, in accordance with some implementations of the disclosure. As illustrated, the predicted 3D shape closely agrees with the ground truth 3D shape. In the 3D case, two views of the USS wire were provided, a top view and a side view.

The foregoing results illustrate that the techniques described herein could be implemented to provide an operator of an USS system with accurate, real-time visual feedback of shape.

In this document, the terms “machine readable medium,” “computer readable medium,” and similar terms are used to generally refer to non-transitory mediums, volatile or non-volatile, that store data and/or instructions that cause a machine to operate in a specific fashion. Common forms of machine readable media include, for example, a hard disk, solid state drive, magnetic tape, or any other magnetic data storage medium, an optical disc or any other optical data storage medium, any physical medium with patterns of holes, a RAM, a PROM, EPROM, a FLASH-EPROM, NVRAM, any other memory chip or cartridge, and networked versions of the same.

These and other various forms of computer readable media may be involved in carrying one or more sequences of one or more instructions to a processing device for execution. Such instructions embodied on the medium, are generally referred to as “instructions” or “code.” Instructions may be grouped in the form of computer programs or other groupings. When executed, such instructions may enable a processing device to perform features or functions of the present application as discussed herein.

In this document, a “processing device” may be implemented as a single processor that performs processing operations or a combination of specialized and/or general-purpose processors that perform processing operations. A processing device may include a CPU, GPU, APU, DSP, FPGA, ASIC, SOC, and/or other processing circuitry.

The terms “substantially” and “about” used throughout this disclosure, including the claims, are used to describe and account for small fluctuations, such as due to variations in processing. For example, they can refer to less than or equal to +5%, such as less than or equal to +2%, such as less than or equal to +1%, such as less than or equal to +0.5%, such as less than or equal to +0.2%, such as less than or equal to +0.1%, such as less than or equal to +0.05%.

To the extent applicable, the terms “first,” “second,” “third,” etc. herein are merely employed to show the respective objects described by these terms as separate entities and are not meant to connote a sense of chronological order, unless stated explicitly otherwise herein.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

While various embodiments of the present disclosure have been described above, it should be understood that they have been presented by way of example only, and not of limitation. Likewise, the various diagrams may depict an example architectural or other configuration for the disclosure, which is done to aid in understanding the features and functionality that can be included in the disclosure. The disclosure is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present disclosure. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosure, whether or not such embodiments are described and whether or not such features are presented as being a part of a described embodiment. Thus, the breadth and scope of the present disclosure should not be limited by any of the above-described exemplary embodiments.

It should be appreciated that all combinations of the foregoing concepts (provided such concepts are not mutually inconsistent) are contemplated as being part of the inventive subject matter disclosed herein. In particular, all combinations of claimed subject matter appearing in this disclosure are contemplated as being part of the inventive subject matter disclosed herein.

What is claimed is:

1. A system, comprising:
a wire comprising multiple ultrasound reflection sites distributed along a longitudinal length of the wire, each of the ultrasound reflection sites comprising a surface feature that alters an acoustic impedance at the wire;
an ultrasound transducer device acoustically coupled to the wire, the ultrasound transducer device configured to:
generate an ultrasound wave signal that travels along the longitudinal length of the wire and partially reflects from each of the ultrasound reflection sites; and
receive a reflected ultrasound waveform signal including data representative of a partial reflection of the ultrasound wave signal by each of the ultrasound reflection sites; and
a processing device configured to:
determine, based on the reflected ultrasound waveform signal, wire shape data of the wire; and
reconstruct, based on the wire shape data, a shape of the wire.

2. The system of claim 1, wherein determining the wire shape data of the wire comprises: predicting, using a trained model, based on the reflected ultrasound waveform signal, the wire shape data of the wire.

3. The system of claim 2, wherein the wire shape data predicted using the trained model comprises multiple angles corresponding to multiple locations along the longitudinal length of the wire.

4. The system of claim 3, wherein each of the multiple angles corresponds to a respective one of the ultrasound reflection sites.

5. The system of claim 2, wherein reconstructing the shape of the wire comprises: reconstructing, using a kinematic model, based on the wire shape data predicted by the trained model, the shape of the wire.

6. The system of claim 1, wherein determining the wire shape data of the wire comprises: determining, using an analytical model of how bending affects an ultrasound wave reflection at each of the surface features, based on the reflected ultrasound waveform signal, the wire shape data of the wire.

7. The system of claim 1, wherein the surface features comprise a first surface feature contacting a surface of the wire with a contact force, the first surface feature made of a material having an acoustic impedance substantially similar to an acoustic impedance of a material of the wire, and the first surface feature configured to create an acoustic impedance shift that is proportional to the contact force.

8. The system of claim 7, wherein the first surface feature is a sleeve pressed on a surface of the wire.

9. The system of claim 1, wherein the processing device is further configured to generate a display of the reconstructed shape of the wire.

10. The system of claim 9, wherein the wire is a guidewire of a medical instrument.

11. The system of claim 1, wherein:
at least two of the surface features are circumferentially offset about a surface of the wire; and
reconstructing the shape of the wire comprises: reconstructing based on the wire shape data, a three-dimensional (3D) shape of the wire.

12. The system of claim 11, wherein the processing device is further configured to generate a display of the 3D shape of the wire that was reconstructed, the display comprising:
a display of the wire from a first view; and
a display of the wire from a second view substantially orthogonal to the first view.

13. A method, comprising:
generating, using an ultrasound transducer acoustically coupled to a wire, an ultrasound signal that travels along a longitudinal length of the wire, the wire including multiple ultrasound reflection sites, each of the ultrasound reflection sites including a surface feature that alters an acoustic impedance at the wire;
obtaining, using the ultrasound transducer, a reflected ultrasound waveform signal including data representative of a partial reflection of the ultrasound signal by each of the ultrasound reflection sites;
determining, based on the reflected ultrasound waveform signal, wire shape data of the wire; and
reconstructing, based on the wire shape data, a shape of the wire.

14. The method of claim 13 wherein: determining the wire shape data of the wire comprises: predicting, using a trained model, based on the reflected ultrasound waveform signal, the wire shape data of the wire.

15. The method of claim 14, further comprising:
synchronously obtaining multiple reflected ultrasound waveform data signals and multiple images of a wire in a plurality of different wire bending positions;
deriving wire shape data from the multiple images; and
constructing, based on the multiple reflected ultrasound waveform data signals and the wire shape data derived from the multiple images, the trained model.

16. The method of claim 14, wherein reconstructing the shape of the wire comprises: reconstructing, using a kinematic model, based on the wire shape data predicted by the trained model, the shape of the wire.

17. The method of claim 13, wherein:
the wire is a guidewire of a medical instrument; and
the method further comprises: displaying, during a medical procedure, an image of the reconstructed shape of the guidewire.

18. The method of claim 17, wherein:
at least two of the surface features are circumferentially offset about a surface of the wire;
reconstructing the shape of the wire comprises: reconstructing based on the wire shape data, a three-dimensional (3D) shape of the guidewire; and
displaying the image of the shape of the guidewire that was reconstructed comprises: displaying a first image of the guidewire from a first plane, and displaying a second image of the guidewire from a second plane substantially orthogonal to the first plane.

19. The method of claim 17, further comprising: dynamically updating, during the medical procedure, the displayed image of the reconstructed shape of the guidewire.

20. The method of claim 13, further comprising: acoustically coupling the ultrasound transducer to the wire.
